(19) United States
(12) Patent Application Publication
(10) Pub. No.: US 2026/0288698 A1
(43) Pub. Date: Sep. 24, 2026

(54) GENERATING STRONG CONSISTENCY AMONG APPLICATIONS BY UTILIZING VERSIONING AND AN ORDERED OBJECT UPDATE QUEUE

(71) Applicant: Dropbox, Inc., San Francisco, CA (US)

(72) Inventors: Patrick Lightbody, Portland, OR (US); Andrew Frieze, Missoula, MT (US); Chris Jones, Portland, OR (US); Josh Jensen, Eagle Mountain, UT (US)

(21) Appl. No.: 19/082,673

(22) Filed: Mar. 18, 2025

(51) Int. Cl. G06F 16/23; G06F 16/27; G06Q 10/1093

(52) U.S. Cl. CPC G06F 16/2365; G06F 16/27; G06Q 10/1093

(57) ABSTRACT

The present disclosure relates to systems, non-transitory computer-readable media, and methods for determining a designated object version of a data object. In one or more embodiments, the disclosed systems can store a data object comprising structured code that defines object parameters of the data object at a centralized object synchronization platform. The disclosed systems can further receive an object update (to the data object that modifies the structured computer code of the data object. In some cases, the disclosed systems can place the object update in an ordered object update queue and compare the object update version associated with the object update with a stored object version of the data object in chronological order. Based on the comparison, the disclosed systems can determine a designated object version for the data objects at the centralized object synchronization platform.

### BACKGROUND

Recent years have seen significant developments in digital scheduling platforms. Indeed, the increase in such online activity has led to several actors and/or agents modifying and coordinating digital schedule instances that affect multiple user accounts across various applications. Indeed, the increase of online scheduling activity has led to users employing several scheduling platforms. To deal with the increased popularity, some conventional systems try to connect or unite scheduling platforms for user accounts. However, while conventional systems unite disparate platforms, conventional systems lose track of digital schedule instances and changes to the digital schedule instances especially when conventional platforms automate the scheduling of certain digital schedule instances for a user account. The inability for some conventional systems to synchronize various scheduling applications leads to several problems in relation to accuracy and efficiency.

As just mentioned, many existing systems are inaccurate, particularly when it comes to multiple actors (e.g., user accounts or automated agents) generating digital schedule instances across multiple scheduling platforms (or third-party applications). For example, as indicated above, some conventional systems can attempt to sync scheduling applications; however, some existing systems face integration issues, making it difficult to share information across the scheduling platforms. For example, some existing systems cannot handle or accurately propagate multiple changes to digital schedule instances generated by multiple actors across different scheduling platforms. The inability to accurately sync up-to-date information leads to scheduling conflicts, missed notifications, and difficulty coordinating schedules used for work, personal life, or other commitments.

In addition to their inaccurate analysis, existing systems suffer from inefficiency. More specifically, because some existing systems inaccurately modify digital schedule instances, such existing systems require excessive back-and-forth communications with client devices to ensure that various schedules on different scheduling platforms accurately reflect information about digital schedule instances. Such inefficiency is compounded by automated actors that follow rules or employ scheduling mechanisms specific to each scheduling platform because automated actors (or agents) can create conflicts between events on different calendaring platforms for multiple user accounts. As a result, many of these existing systems unnecessarily utilize excessive computing resources by processing or re-processing the excessive back-and-forth communications between automated agents associated with calendaring platforms.

On top of these issues, conventional systems face additional problems with regard to scheduling platforms and third-party applications that share similar functions and modify data objects.

### SUMMARY

Embodiments of the present disclosure provide benefits and/or solve one or more of the foregoing or other problems in the art with systems, non-transitory computer readable media, and methods for ensuring strong consistency to data objects (e.g., online meetings or online appointments) across multiple third-party applications. For example, the disclosed systems can store a data object (e.g., online meeting) at a centralized platform where the data object comprises structured code that defines parameters (e.g., data, start time, attendees, provider, etc.) of the data object. The disclosed systems can further receive an object update (or modification) to the data object that modifies the structured computer code of the data object. For example, an object update can include a change in time to an online meeting. In some cases, the disclosed systems can receive the object update and place it in an ordered object update queue in chronological order. In the ordered object update queue, the disclosed systems can compare an object update version associated with the object update with a stored object version of the data object stored at the synchronization platform. Based on the comparison, the disclosed systems can determine a designated object version for the data objects at the centralized platform.

### BRIEF DESCRIPTION OF THE DRAWINGS

The detailed description provides one or more embodiments with additional specificity and detail through the use of the accompanying drawings, as briefly described below.

FIG. 1 illustrates an example overview of an object synchronization system determining a designated object version for a data object in accordance with one or more embodiments.

FIG. 2 illustrates an object synchronization system translating a structure of external object updates in accordance with one or more embodiments.

FIG. 3 illustrates an object synchronization system rejecting an object update in accordance with one or more embodiments.

FIG. 4 illustrates an object synchronization system rejecting a conditional object update in accordance with one or more embodiments.

FIG. 5 illustrates an object synchronization system merging an object update and target object update in accordance with one or more embodiments.

FIG. 6 illustrates another embodiment of an object synchronization system merging an object update and target object update in accordance with one or more embodiments.

FIG. 7 illustrates an example flowchart of a series of acts for determining a designated object version of a data object in accordance with one or more embodiments.

FIG. 8 illustrates a diagram of an environment in which an object synchronization system can operate in accordance with one or more embodiments.

FIG. 9 illustrates an example environment of a networking system having the object synchronization system in accordance with one or more embodiments.

FIG. 10 illustrates a block diagram of an exemplary computing device in accordance with one or more embodiments.

### DETAILED DESCRIPTION

This disclosure describes one or more embodiments of an object synchronization system tracking one or more modifications to a data object. In particular, the object synchronization system can store a data object comprising one or more events, items, individuals, and/or entities in a structured object database. In one or more embodiments, the object synchronization system can receive an object update to the data object from one or more agents and/or third-party applications linked to the centralized synchronization platform. In some cases, the object synchronization system can add the object update to an ordered object update queue where the object synchronization system processes one or more object updates one at a time in chronological order. In one or more embodiments, processing the object update can include comparing an object update version associated with the object update with a stored object version of the data object. Based on comparing the object update version with the stored object version, the object synchronization system can determine a designated object version that reflects a version and/or instance of the data object.

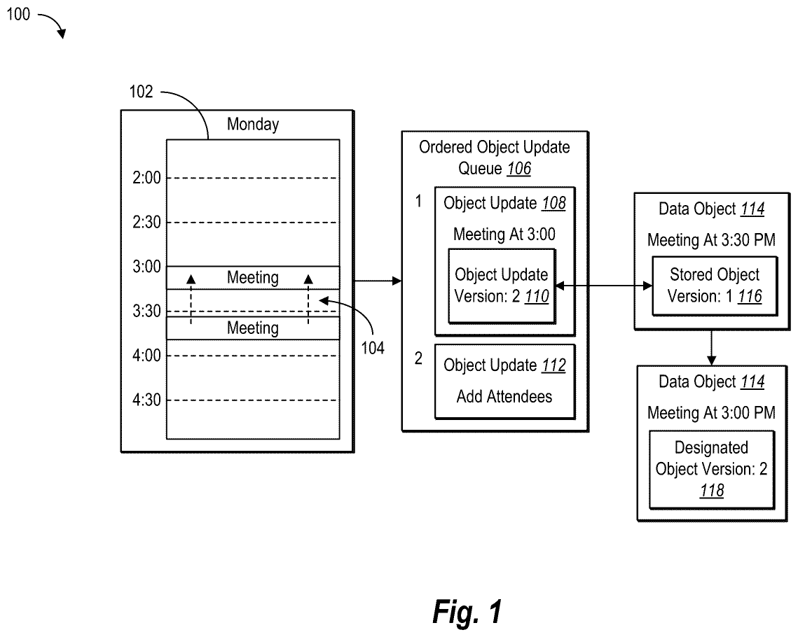

As just mentioned above, the object synchronization system 100 can accurately and efficiently process, track, and monitor one or more changes from one or more actors (e.g., third-party applications, agents, etc.) to a data object. FIG. 1 illustrates an example overview of an object synchronization system determining a designated object version for a data object in accordance with one or more embodiments.

In one or more cases, the object synchronization system 100 can receive from a third-party application a modification 104 to an event (e.g., meeting) associated with a calendar 102 stored on the third-party application. As indicated above, the object synchronization system 100 can generate a data object 114 that corresponds to a function of the third-party application. For example, the object synchronization system 100 can generate the data object 114 that corresponds to the calendar 102. In one or more implementations, the 100 can store the data object 114 on a centralized object synchronization platform. In some embodiments, the data object 114 stored on the centralized object synchronization platform can include structured computer code that defines parameters (e.g., object parameters) of the data object 114. Moreover, the type of data object can define the object parameters of the data object 114. For example, if the data object 114 relates to a calendar and one or more scheduled events, the object parameters can define the attendees, start times, durations, descriptions, locations, links, reminders, status, attachments, etc., of the one or more scheduled events.

As just mentioned, the object synchronization system 100 can receive a modification 104 from the calendar 102 within a third-party application. In one or more cases where the object synchronization system 100 receives the modification 104 from the third-party application (or agent), the object synchronization system 100 can generate an object update 108 that corresponds to and/or represents the modification received from the third-party application. For example, as shown in FIG. 1, the object synchronization system 100 can generate the object update 108 that corresponds to the modification 104 changing the start time of a meeting from 3:30 PM to 3:00 PM.

As mentioned above, in some cases, the object synchronization system 100 can track modifications to the data object 114 by versioning the data object 114 and/or the object update 108. As shown in FIG. 1, the object synchronization system 100 can version the object update 108. In particular, the object synchronization system 100 can generate and/or assign an object update version 110 for the object update 108 by incrementing the object update version 110 based on a previous object update to the data object 114 or the stored object version 116 of the data object 114. For instance, based on the object synchronization system 100 incrementing the stored object version 116 of the data object 114 upon its creation (or entry into the centralized object synchronization platform), the object synchronization system 100 can assign the object update version 110 of two to the object update 108.

As further shown in FIG. 1, the object synchronization system 100 can compare the object update version 110 of the object update 108 with a stored object version 116 of the data object 114 stored on the centralized object synchronization platform. In particular, the object synchronization system 100 can compare the object update version 110 with the stored object version 116 according to an ordered object update queue 106. In some embodiments, the object synchronization system 100 can process the object updates in chronological order. In particular, the object synchronization system 100 can process changes through the ordered object update queue 106 based on the timing, source, and/or user account of the updates. For example, as shown in FIG. 1, since the object synchronization system 100 received the object update 108 prior to an additional object update 112, the object synchronization system 100 processes the object update 108 before the additional object update 112.

As FIG. 1 illustrates, the object synchronization system 100 can determine a designated object version 118 for the data object 114 stored at the centralized object synchronization platform. For example, based on the object update version 110 exceeding the stored object version 116, the object synchronization system 100 can determine that the change (or object update 108) is novel or new. Based on the novelty of the object update 108, the object synchronization system 100 can update the stored object version 116 to a designated object version 118 that represents the most current version of the data object 114. In some cases, the object synchronization system 100 determines the designated object version 118 by incrementing the stored object version 116. As shown in FIG. 1, the designated object version 118 can match the object update version 110. In one or more cases, the object synchronization system 100 can store the designated object version 118 and the designated object version 118 can become the stored object version for the data object for future object updates. Thus, the object synchronization system 100 tracks all changes to the data object 114 through versioning the data object 114 (e.g., designated object version or stored object version) and ensures that all of the changes to the data object 114 are processed and propagated to affected applications (e.g., third-party applications).

As indicated above, the object synchronization system 100 provides a number of advantages over conventional systems. For example, the object synchronization system 100 system provides improved accuracy, flexibility, and efficiency over existing systems. As indicated above, the increased popularity in online events and meetings has led to users employing multiple calendaring platforms. As a result, users (or agents) do not see scheduling conflicts, have reduced visibility of events, have difficulty coordinating information across scheduling platforms, inconsistently update changes to events across multiple platforms, and face integration issues while synching different calendaring platforms. Unlike such systems, the object synchronization system 100 enables an encompassing view of events on disparate calendaring platforms by providing a calendar platform (or third-party application) agnostic system that atomically processes and versions one or more modifications to multiple events spread across calendaring platforms for user accounts.

By processing each modification to an event one at a time, the object synchronization system 100 can address or avoid conflicts between scheduling platforms, improve visibility of events on different scheduling platforms, consistently apply modifications and/or updates to various events, and successfully sync information across each calendaring platform by relying on accurate and up-to-date information from each calendaring platform and/or agent. For example, the object synchronization system 100 can utilize a series of rules on how to address scheduling conflicts that originate from different calendaring platforms or agents. Moreover, the object synchronization system 100 can employ a system that ensures the object synchronization system 100 relies on the most accurate and up-to date information while modifying events (or other objects). Unlike existing systems, the object synchronization system 100 ensures strong consistency and/or convergence of events spread across calendaring platforms for one or more user accounts.

On top of improved accuracy, the object synchronization system 100 provide improved flexibility for modifying events (or other objects) across scheduling platforms (or third-party applications). For example, calendaring platforms can act like different databases that have different interfaces, structures, requirements, and/or constraints. The object synchronization system 100 abstracts these differences by generating platform agnostic data objects that can be consistently modified within the object synchronization system 100 and applied to one or more calendaring platforms. Thus, the object synchronization system 100 flexibly allows multiple changes from multiple actors across multiple platforms to platform agnostic data objects and can flexibly propagate those changes across one or more calendaring platforms providing an accurate and broad view of scheduled events spread across multiple calendars.

Moreover, the object synchronization system 100 improves computational efficiency over existing systems. For instance, unlike some existing systems that require actors to add the same event (or data object) and process modifications (e.g., object updates) to the same event on each calendaring platform (or third-party application), the object synchronization system 100 can modify various events in a single calendaring platform (or third-party application) agnostic space and push the modifications to each calendaring platform. Thus, the object synchronization system 100 does not spend computing resources redundantly processing the same information on different calendar platforms. In some cases, the object synchronization system 100 can save computational resources my merging various modifications to events. As indicated below, the benefits of the object synchronization system 100 can go beyond calendaring platforms and apply to third-party applications that share functionality. Indeed, the object synchronization system 100 can utilize the versioning method described below to address changes to objects representing projects, entities, individuals, documents, etc. that come from multiple actors (e.g., user accounts or automated agents) and disparate third-party applications.

Moreover, the object synchronization system 100 solves technological problems that specifically arose due to computer calendaring platforms. Indeed, as discussed above, the due to the nature of calendars syncing with one another over networks (e.g., the internet) and the advent of calendaring agents (both human and electronic) that have the ability to update calendar events simultaneously, there arose a technological problem of keeping electronic calendars free from event conflicts within a technological area where there is no single source of truth. Due to these technological problems, a calendar associated with a user account could easily become cluttered with overlapping events, with no specific technological solution for resolving the conflicts. While some platforms have developed hardline rules to avoid conflicts, these rules often only result in a constant change loop where one or more actors constantly change events based on one or more sets of defined rules or priority hierarches. The object synchronization system 100 solves this problem by providing a process by which modifications are not allowed into a conflicting state based on securely and reliably causing the various potential modification requests to consolidate to a stable state, thus solving the problems created specifically within the digital calendaring platforms.

As illustrated by the foregoing discussion, the present disclosure utilizes a variety of terms to describe features and benefits of the object synchronization system 100. Additional detail is hereafter provided regarding the meaning of these terms as used in this disclosure. As used herein, the term “data object” includes or refers to data outlining attributes, values, and/or properties about one or more events, individuals, entities, or items. In one or more embodiments, a data object can include parameters (e.g., object parameters) defining properties, attributes, and/or features of a single event, entity, individual, content item, etc., associated with the data object. For example, a data object can be a scheduled event (or calendar event) associated with a calendar of a user account comprising parameters defining the start time, duration, location, attendees, description, links, etc., of the scheduled event. In one or more cases, the data object can include structured computer code that defines the parameters of the event, individual, entity, and/or item. For example, in some cases, the data object can be a data table with various fields related to the parameters related to the data object. In one or more cases, the data object can correspond to a target object generated within a third-party application (e.g., target third-party application or additional third-party application).

Relatedly, as used herein, the term “object update” includes or refers to a change, modification, and/or update to the data object. In some cases, a data object can comprise modifying the object parameters of the data object by modifying the structured computer code of the data object. For example, if the data object is a scheduled event and the object update changes the start time of a scheduled event, the object update can modify the structured computer code defining the parameters of the scheduled event to reflect the new start time.

Relatedly, as used herein, the term “object update version” includes or refers to a version, instance, and/or status of an object update. In one or more cases, the object synchronization system 100 can receive one or more object updates to object parameters associated with the data object. For example, the object synchronization system 100 can receive multiple object updates from an internal (or automated) agent to the data object. In one or more cases, the object synchronization system 100 can track the object updates from the internal agent by incrementing the object update versions of the object updates from the internal agent.

As used herein, the term “structured computer code” includes or refers to one or more instructions that can be executed by a computing device. In one or more embodiments, a computing device can perform one or more tasks by executing the structured computer code. In some cases, structured computer code can be in a programming language such as, but not limited to, JavaScript, Java, Python, Structured Language Query (SQL), C++, PHP, C#, Dart, Go, Kotlin or Perl. In one or more embodiments, structured computer code can represent a data object and information about the data object.

As used herein, the term “stored object version” includes or refers to a stored version, instance, and/or status of the data object. For example, a stored object version can reflect the version and/or number of changes (e.g., object updates) applied to the data object. To illustrate, a first stored object version can reflect the initial state of the data object, and a second stored object version can reflect a second modification to the data object.

Additionally, as used herein, the term “ordered object update queue” includes or refers to a pipeline that processes object updates and/or target object updates according to a chronological sequence, order, and/or chain. For example, the ordered object update queue ensures that the object synchronization system 100 processes each object update (and/or target object update) from different agents (or actors) and various platforms (e.g., third-party applications) and propagates current and correct information across the various platforms (e.g., third-party applications).

Moreover, as used herein, the term “designated object version” includes or refers to a version of a data object when propagating the object update across applications and/or systems. In one or more cases, the designated object version can reflect the most current and/or existing version of the data object. For example, in some cases, the object synchronization system 100 can receive modifications (e.g., object updates or target object updates) from agents within the centralized object synchronization platform and/or external third-party applications linked to the centralized object synchronization platform. In such instances, the object synchronization system 100 can generate the designated object version to reflect each instance and/or version of the data object based on the modifications and/or updates to the data object. In some cases, the object synchronization system 100 can store the designated object version as a stored object version (or additional stored object version) of the data object for subsequent processing of object updates, target object updates, and/or additional object updates to the data object.

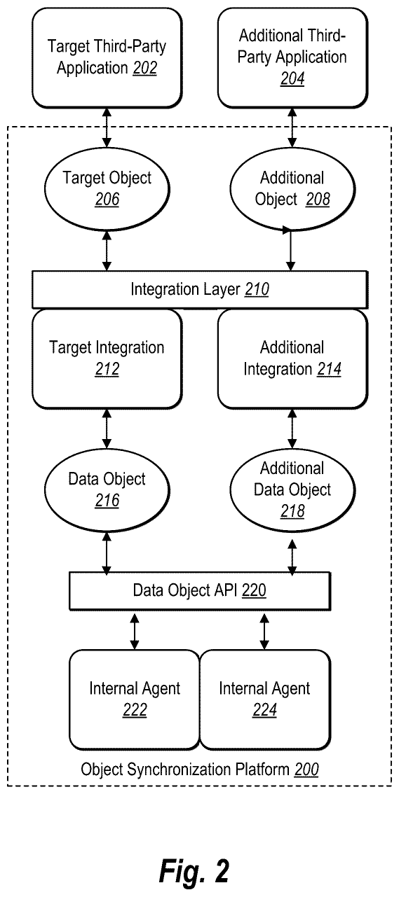

As indicated above, the object synchronization system 100 can generate a data object that corresponds to a function, type, and/or feature of one or more applications (e.g., third-party applications or internal applications). For example, in one or more embodiments, the object synchronization system 100 can generate a data object related to scheduling (or calendaring) with object parameters representing, event attendees, an event location, duration of the event, etc. In one or more embodiments, after generating the data object, the object synchronization system 100 can further receive updates (e.g., object updates, target object updates, additional object updates) to one or more data objects by receiving modifications from the third-party application and/or other agents. FIG. 2 illustrates the object synchronization system 100 generating a data object by receiving one or more objects (e.g., target objects or additional objects) from external third-party applications in accordance with one or more embodiments.

As shown in FIG. 2, the object synchronization system 100 can link one or more third-party applications (or agents) to a centralized object synchronization platform 200. In some cases, the object synchronization system 100 can receive a target object 206 from one or more third-party applications (e.g., target third-party application 202 or additional third-party application 204) linked to a centralized object synchronization platform 200. In some cases, the third-party applications can share similar functions and/or features, such as, but not limited to, calendaring, project management, resource management, security management, financial management, healthcare management, data analysis, digital communication, content generation, image editing, and/or task management. For example, in some embodiments, the target third-party application 202 and the additional third-party application 204 can relate to calendaring.

As just indicated, the object synchronization system 100 can receive one or more objects (e.g., target object 206 or additional object 208) from third-party applications (e.g., target third-party application 202 or additional third-party application 204). In some cases, the target object 206 can represent an event, item, user account, project, entity, etc., and include information related to the event, item, user account, project, entity, etc. For example, the target object 206 can be an event such as a meeting and include information (or external object parameters) about the location, start time, duration, and meeting attendees. Alternatively, in one or more cases, based on the function of the third-party application the target object 206 can be a project and include information (or external object parameters) about tasks, involved departments, and/or deadlines associated with the project.

As shown in FIG. 2, the object synchronization system 100 can receive the target object 206 associated with the target third-party application 202. As indicated above, the structure and/or formatting of the data of the target object 206 can differ from the data structure of the data object 216 within the centralized object synchronization platform 200. In one or more implementations, the object synchronization system 100 manages, tracks, and/or processes the target object 206 and/or the additional object 208 received from third-party applications (or agents) by translating the structure of the computer code defining parameters of the target object 206 to a standardized structure associated with the data object 216 and utilized within the centralized object synchronization platform 200.

As shown in FIG. 2, the object synchronization system 100 can utilize an integration layer 210 to translate the structure of the target object 206 associated with the target third-party application 202 to the standard structure and/or format of data object 216 utilized within the centralized object synchronization platform 200. In one or more cases, as shown in FIG. 2, the integration layer 210, can include one or more integrations that handle the domain associated with the external third-party applications. For example, the integration layer 210 can include a target integration 212 that translates the structure and/or formatting of the target object 206 originating from the target third-party application 202 to the data object 216 with standardized structure and/or format of the centralized object synchronization platform 200. In some cases, the target integration 212 can include a plug-in associated with the target third-party application 202 that can handle and/or translate the target object 206 into the data object 216. In one or more embodiments, the object synchronization system 100 can generate multiple data objects for target objects within a target calendar of the target third-party application. As described in more detail below, the object synchronization system 100 can batch and process multiple data objects received from the target third-party application.

As further shown in FIG. 2, the object synchronization system 100 can receive an additional object 208 comprising external object parameters from an additional third-party application 204. As FIG. 2 illustrates, the integration layer 210 can include an additional integration 214 that can translate and add the additional object 208 to an additional data object 218. As described above, the additional integration 214 can be a plug-in (or additional plug-in) that can handle and translate the additional object 208 into the additional data object 218. As described above, the object synchronization system 100 can translate a plurality of additional objects from the additional third-party application 204 to generate a plurality of additional data objects to be processed by the object synchronization system 100. In some cases, the object synchronization system 100 can link any number of third-party applications (or agents) to the centralized object synchronization platform 200 and generate integrations (e.g., plug-ins) to translate additional objects (e.g., additional events and/or items) into additional data objects.

As just described, in one or more embodiments, the object synchronization system 100 can receive an object (e.g., target object 206 and additional object 208) from third-party applications to generate the data object 216 and the additional data object. Indeed, the object synchronization system 100 can generate the data object 216 and additional data object 218 that are application and/or platform agnostic, which as indicated above enables accurate tracking of modifications to the data object 216 and the additional data object 218.

In some cases, the object synchronization system 100 can receive modifications and/or updates (e.g., external object update) to the data object 216 from the target third-party application 202 (and/or the additional third-party application 204). In some cases, the object synchronization system 100 can utilize the integration layer 210 to translate an external object update (e.g., external target object update) to a target object update that follows the standardized formatting within the centralized object synchronization platform 200 and modifies the structured computer code of a data object (e.g., target object 206, additional object 208). In some embodiments, the object synchronization system 100 can receive the external object update via the target object 206 and/or the additional object 208. For example, the target object 206 can reflect a modification to an event, item, entity, object, etc. generated within the target third-party application 202.

As further shown in FIG. 2, the object synchronization system 100 can include one or more agents (or actors) within and/or associated with the centralized object synchronization platform 200 that can interact with and/or modify aspects of the data object 216. For example, in some cases, the internal agents 222, 224 can perform a function related to the target third-party application 202 and/or the additional third-party application 204. For example, if the function of the target third-party application 202 and/or the additional third-party application 204 relates to calendaring, the functions of the internal agent 222 and the internal agent 224 can also relate to calendaring. For instance, the internal agent 222 can perform a function of intelligently scheduling meetings or events between several calendars associated with various user accounts. In some cases, the internal agent 224 can perform a function of identifying habits of a user account and dynamically scheduling time for such habits based on certain rules and potential conflicts. In some implementations, the object synchronization system 100 and/or the centralized object synchronization platform 200 can include any number of internal actors, agents, or features related to the function of the target third-party application 202 and/or the additional third-party application 204.

As just discussed, the object synchronization system 100 and/or the centralized object synchronization platform 200 can include internal agents 222, 224 that can perform actions related to the function of the target third-party application 202 and/or the additional third-party application 204. In particular, the internal agents 222, 224 can modify the data object 216. For instance, the internal agent 222 can generate an object update that modifies the structured computer code of the data object 216. For example, the data object 216 can be a meeting with an object parameter indicating that the start time is scheduled for 3:00 PM on a Thursday. Based on one or more arising conflicts with one of the attendees, the object synchronization system 100, via the internal agent 222, can generate an object update that modifies the structured computer code defining the object parameter, indicating a start time of 3:00 to 2:00 so that all attendees can join the meeting.

As just indicated, the internal agents 222, 224 can interact and modify the data object 216 via an object update. As shown in FIG. 2, the internal agents 222, 224 can modify and/or interact with the data object 216 via a data object API 220. In one or more embodiments, the data object API 220 can be a uniform API or other uniform interface that enables communication between the data object 216 and the internal agents 222, 224.

By utilizing the data object API 220 and a standardized format for data objects and object updates, the object synchronization system 100 can modify the parameters of the data object 216 and track the modifications (e.g., object updates) to ensure strong convergence for one or more data objects that receive multiple modifications from multiple actors from different platforms and/or systems.

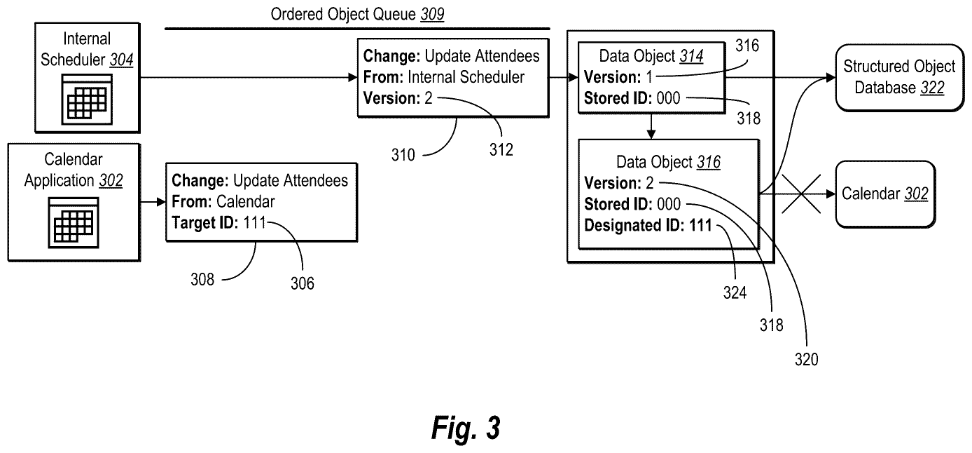

As just described, the object synchronization system 100 can receive modifications to data objects from internal agents and/or external third-party applications. As indicated above, the object synchronization system 100 can utilize an ordered object update queue to sequentially and chronologically handle and/or process modifications (e.g., object updates or target object updates) to a data object and determine a designated object version that reflects the most current version of the data object. FIG. 3 illustrates the object synchronization system 100 determining a designated object version for a data object based on receiving an object update from an internal agent and a target object update from a target third-party application in accordance with one or more embodiments.

As shown in FIG. 3, the object synchronization system 100 can receive an object update 310 from an internal agent (e.g., the internal schedular 304) modifying a data object 314 representing a scheduled event associated with a user account. Additionally, the object synchronization system 100 can receive a target object update 308 from a calendar application 302 modifying the data object 314 (e.g., scheduled event). As indicated above, the object synchronization system 100 processes object updates and/or target object updates one at a time in chronological order within an ordered object update queue 309. For instance, the object synchronization system 100 can process the target object update 308 and/or object update 310 based on the timing, source, and/or user account associated with the data object 314, the object update 310 and/or target object update 308. For example, as shown in FIG. 3, the ordered object update queue 309 received the object update 310 from the internal schedular 304 before receiving the target object update 308 from the calendar application 302. Based on the ordered object update queue 309 receiving the object update 310 first, the object synchronization system 100 can process the object update 310 before the target object update 308. The ordered object update queue 309 can ensure that only one actor (e.g., the calendar application 302 or the internal schedular 304) modifies the state of the data object 314 at any time.

Additionally, in one or more cases, the object synchronization system 100 can ensure accurate convergence for one or more data objects by partitioning modifications (e.g., object updates target object updates, and/or additional object updates) to the data object 314 (or additional data object) based on the user account and third-party application associated with the data object 314. For example, in one or more cases, the object synchronization system 100 can identify the user account associated with the data object 314 and batch modifications (e.g., object updates target object updates, and/or additional object updates) to the data object 314 together based on the source (e.g., target third-party application, additional third-party application, internal agent, etc.) of the modification (e.g., object updates target object updates, and/or additional object updates). For example, in one or more embodiments, the object synchronization system 100 will place the batch of target object updates from the calendar application 302 associated with the user account in the ordered object update queue 309 for processing. Once the object synchronization system 100 finishes processing the batch of target object updates, the object synchronization system 100 can process an additional batch of additional object updates associated with an additional third-party application. Thus, the object synchronization system 100 can atomically process each target object update, additional object update, and/or object update in a related manner.

As just mentioned, the object synchronization system 100 can batch object updates, target object updates, and/or additional object updates based on the user account and/or platform (e.g., target third-party application). In some cases, the object synchronization system 100 can detect a failed update status while applying a target object update 308 and/or object update 310 to a third-party application (e.g., target third-party application, additional third-party application, etc.). For instance, in one or more cases, third-party applications can have rate limits that limit the number of changes originating from the object synchronization system 100 for a given period of time. For example, in some cases, the target third-party application (e.g., calendar application 302) can only accept 50 to 100 modifications (e.g., object updates and/or target object updates) for one minute and can reject any modifications pushed by the object synchronization system 100 for a certain amount of time. In such cases, the object synchronization system 100 cannot (or will not) apply (or push) target object updates and/or object updates for a period of time (e.g., 30 seconds, one minute, five minutes, etc.) to the target third-party application. In one or more implementations, the object synchronization system 100 can place the batches of one or more target object updates and/or object updates in a hold state and hold back the target object updates and/or object updates for a period of time based on the rate limit of the target third-party application. For example, the object synchronization system 100 can pause processing the target object updates and/or object updates within the ordered object update queue 309 for 30 seconds because the target third-party application rejects modifications for 30 seconds after the object synchronization system 100 reaches the rate limit of 100 modifications. In one or more implementations, the object synchronization system 100 can pause processing of the target object updates via a target ordered object update queue associated with the target integration described above in FIG. 2. In particular, the target integration can include a unique queue for receiving modifications (e.g., inbound changes) to the data object from the target third-party (e.g., calendar application 302). In some cases, the object synchronization system 100 can pause processing of the integration of the changes to the data object according to the rate limit of the target third-party application within the target ordered object update queue. In one or more embodiments, the object synchronization system 100 can continue processing additional object updates from one or more additional third-party applications and/or one or more internal agents (e.g., internal schedular 304) within the ordered object update queue 309, while the object synchronization system 100 pauses processing of the changes from the target third-party application.

In some implementations, the object synchronization system 100 can detect a change to the failed update status of the target third-party application and continue processing the target object updates and/or object updates and pushing the target object updates and/or object updates to the target third-party application. Relatedly, the object synchronization system 100 can detect a failed status update from one or more additional third-party applications linked to the centralized object synchronization platform and process the target object updates and/or object updates according to the one or more rate limits associated with the one or more additional third-party applications. For example, in some implementations, the object synchronization system 100 can continue processing translation of one or more modifications to a target event within the target ordered object update queue and push those modifications to the ordered object update queue 309.

As indicated above, the object synchronization system 100 can process the object update 310 before the target object update 308. In one or more embodiments, processing the object update 310 can include running the object update 310 through a series of rules and comparing an object update version 312 with a stored object version 316 of the data object 314 stored at the centralized object synchronization platform. In some cases, the series of rules can outline how to prioritize certain object modifications (e.g., a user-originated modification, a scheduled modification, an internal agent-originated modification, etc.), how to handle specifics and/or modifications (e.g., target object updates) sourced from certain target third-party applications and/or additional third-party applications, and/or merging object updates and/or target object updates. For instance, the series of rules can prioritize user-originated modifications and reject the object update 310 that conflicts with a user-originated modification received via a target third-party application. In some cases, the object synchronization system 100 can lock-in user originated modifications and reject any modification generated by an internal (or automated agent) that conflicts or affects the user originated modification. In some cases, the series of rules can be specific to each third-party application. For example, the series of rules for modifications to the target third-party application can differ from the series of rules for modifications to the additional third-party application.

In one or more implementations, after running the object update 310 through the series of rules, the object synchronization system 100 can compare the object update version 312 of the object update 310 with a stored object version 316 of the data object 314. As indicated above, the stored object version 316 of the data object 314 can indicate the most recent and/or current version of the data object 314 known by the object synchronization system 100. For example, as shown in FIG. 3, the stored object version 316 of the data object 314 is one. Relatedly, as shown in FIG. 3, the object update version 312 of the object update 310 is two. In some cases, the object synchronization system 100 can determine the object update 310 by incrementing the stored object version 316. For example, since the object update 310 is the first modification to the data object 314, the object synchronization system 100 can increment the stored object version 316 by one and assign an object update version 312 of two to the object update 310.

As shown in FIG. 3, the object synchronization system 100 can compare the object update version 312 of the object update 310 with the stored object version 316 of the data object 314 to determine if the modification to the data object 314 is novel. In one or more cases, the object update 310 is novel if the object update version 312 exceeds the stored object version 316. As FIG. 3 illustrates since the object update version 312 of two exceeds the stored object version 316 of one, the object synchronization system 100 can determine that the modification (e.g., object update 310) to the data object 314 is novel and determine a designated object version 320 of the data object 314 stored at the centralized object synchronization platform.

In one or more embodiments, based on the novelty of the object update 310, the object synchronization system 100 applies (or pushes) the object update 310 (or modified data object) to a third-party application (e.g., target third-party application and/or one or more additional third-party applications). In one or more embodiments, the object synchronization system 100 applies the object update 310 (or modified data object) to the target third-party application and/or one or more additional third-party applications) based on comparing a target object version identifier 306 (or additional object version identifier) associated with the target third-party application (e.g., calendar application 302) and a stored object version identifier 318. For instance, in some cases, third-party applications track changes to and/or versions of one or more target objects by utilizing identifiers associated with the third-party application, such as entity tags (ETags), change keys, content hash, conditional GETs, etc. In particular, based on receiving one or more changes to a target object, a target third-party application can update the ETag of the target object and indicate the most current version of the target object (e.g., scheduled event) of a target calendar associated with the target third-party application (e.g., calendar application 302).

In one or more implementations, the data object 314 stored on the centralized object synchronization platform can include a stored object version identifier 318. In some embodiments, the stored object version identifier 318 can indicate the latest version of the target object on the third-party application accessed and/or known by the object synchronization system 100. In one or more implementations, the stored object version identifier 318 does not match the target object version identifier 306 of the target third-party application (e.g., calendar application 302), resulting in the object synchronization system 100 not storing and/or relying on the most recent information of the target object (or target calendar) stored on the calendar application 302. For instance, as shown in FIG. 3, the calendar application 302 received the target object update 308 to the data object 314 associated with a target object (e.g., scheduled event) via the calendar application 302 before processing the object update 310 and applying the change represented by the object update 310 to the target object on the calendar application 302. In particular, as shown in FIG. 3, the stored object version identifier 318 of 000 does not match the most recent target object version identifier 306 of 111 associated with the target object within the calendar application 302. In one or more implementations, the object synchronization system 100 pulls the latest modification from the target object (e.g., scheduled event) of the target third-party application and updates the stored object version identifier 318 to reflect the current version, state, and/or instance of the target object on the calendar application 302. As shown in FIG. 3, in some cases, the object synchronization system 100 can update the stored object version identifier 318 by generating and/or storing a designated object version identifier 324 that reflects the most recent version, state, and/or instance of the target object associated with the data object 314 and stored on the calendar application 302 known by the object synchronization system 100. In some cases, the designated object version identifier 324 matches the target object version identifier 306 of the target object update 308 based on the target object version identifier 306 representing the most recent version and/or change to the target object within the calendar application 302.

Additionally, in one or more embodiments, if the stored object version identifier 318 does not match the current target object version identifier 306, the object synchronization system 100 can pull the latest version of the target object, including the target object version identifier 306 from the calendar application 302, update the stored object version identifier 318 of the data object 314 to match the target object version identifier 306, and store the target object version identifier 306 in a structured object database 322.

In some cases, after updating the stored object version identifier 318 to match the current and/or most recent target object version identifier 306 for the target object, the object synchronization system 100 can check for conflicts and/or compatibility between the target object update 308 to the target object and the object update 310 to the data object 314 associated with the target object. For example, based on the target object update 308 and object update 310 modifying the same parameter, attendees for the scheduled event, the object synchronization system 100 can determine that the object update 310 conflicts with target object update 308 and reject the object update 310.

As shown in FIG. 3, since the object update 310 updates attendees for the data object 314, and the target object update 308 updates attendees for the data object 314, the two modifications conflict, and the object synchronization system 100 rejects and does not apply the object update 310 to the target object (e.g., scheduled event) on the calendar application 302. In some cases, when the object synchronization system 100 rejects the object update 310, the object synchronization system 100 can push the designated object version 320 to the internal scheduler 304 in order to converge the version of the stored object version 316. In one or more implementations, if the object synchronization system 100 rejects a modification (e.g., object update or additional object update) from a target third-party application or additional third-party application, the object synchronization system 100 can push the current object version associated with the data object or additional data object to the target third-party application or additional third-party application. Alternatively, in one or more embodiments, the object synchronization system 100 can apply the object update 310 to the target object within the calendar application 302 if the object update 310 does not conflict with the target object update 308 and/or any other target object updates.

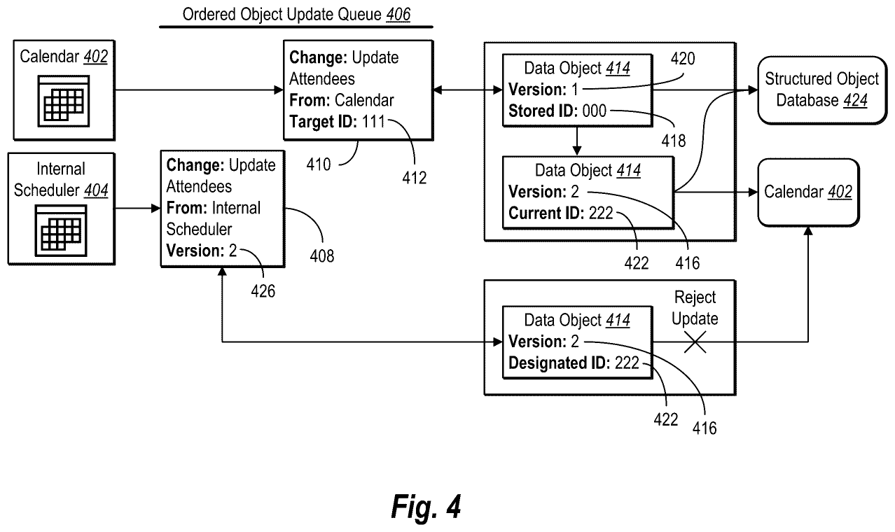

As just discussed, the object synchronization system 100 can receive an object update modifying a data object from an internal scheduler. As discussed above, the order of applying object updates and/or target object updates to a data object can affect the application of the changes to the target object within the third-party application (e.g., target third-party application and/or additional third-party application). FIG. 4 illustrates the object synchronization system 100 rejecting a stale object update in accordance with one or more embodiments.

As shown in FIG. 4, the object synchronization system 100 can receive a target object update 410 to a target object (e.g., scheduled event) associated with a user account on the calendar application 402. As shown in FIG. 4, the target object update 410 can modify a parameter of the target object. For example, the target object update 410 can modify the attendees associated with a scheduled event. As discussed above, in one or more embodiments, the target object update 410 can include a target object version identifier 412 that represents the most recent version of the target object within the calendar application 402 that reflects the change to the attendees.

As shown in FIG. 4 and as discussed above, the object synchronization system 100 can also receive an object update 408 from an internal scheduler 404. As FIG. 4 illustrates, the object synchronization system 100 can process the target object update 410 before processing the object update 408. As described above, in one or more embodiments, the object synchronization system 100 can run the target object update 410 through a series of rules.

In one or more embodiments, upon running the target object update 410 through the series of rules, the object synchronization system 100 can determine a designated object version 416 by comparing a target object version identifier 412 of the target object update 410 with a stored object version identifier 418 of a data object 414 stored on a centralized object synchronization platform. For example, the object synchronization system 100 can determine the novelty of the target object version identifier 412 based on the target object version identifier 412 (e.g., 111) matching or exceeding the stored object version identifier 418 (e.g., 000) of the data object 414 stored on the centralized object synchronization platform. In one or more embodiments, if the target object version identifier 412 is less (or smaller) than the stored object version identifier 418, the object synchronization system 100 can reject the target object update 410 because it is not the most recent version of the target object within the calendar application 402.

As further shown in FIG. 4, upon determining that the target object update 410 is a novel modification to the data object 414, the object synchronization system 100 can update a stored object version 420 of the data object 414 to the designated object version 416. For example, as shown in FIG. 4, the object synchronization system 100 can update the stored object version 420 from one to the designated object version 416 of two. As FIG. 4 illustrates, in one or more cases, the object synchronization system 100 can further update the stored object version identifier 418. In particular, the object synchronization system 100 can attempt to push the target object update 410 to the calendar application 402. In some implementations, while applying the target object update 410, the object synchronization system 100 can increment the stored object version identifier 418 based on the target object version identifier 412 to generate a designated object version identifier 422 that reflects the most recent and/or current version of the target object within the calendar application 402.

In one or more embodiments, the object synchronization system 100 can propagate the target object update 410 made to the data object 414 to one or more additional third-party applications. For example, the object synchronization system 100 can push the changes (e.g., target object update 410 and/or object update 408) to the data object 414 out to one or more additional third-party applications. For example, based on receiving the target object update 410 of changing attendees to the data object 414, the object synchronization system 100 can push the attendees change to an additional calendar application with the same scheduled event.

As shown in FIG. 4, the object synchronization system 100 can store the designated object version 416 in a structured object database 424. In some cases, the object synchronization system 100 can store various object version identifiers associated with various third-party applications.

As FIG. 4 further illustrates, the object synchronization system 100 can receive and/or process the object update 408 to the data object 414 from the internal scheduler 404 after the target object update 410 via the ordered object update queue 406. As shown in FIG. 4, when the object synchronization system 100 processes the object update 408object update 408, the object synchronization system 100 can store the designated object version 416designated object version 416designated object version 416 and designated object version identifier 422 and the designated object version 416 can become a stored object version of the data object 414 for comparing the object update version 426 of the object update 408.

As discussed above, the object synchronization system 100 can compare an object update version 426 of the object update 408 with the designated object version 416. As shown in FIG. 4, the designated object version 416 of the data object 414 matches the object update version 426 of the object update 408. Based on the object update version 426 matching the designated object version 416, the object synchronization system 100 can determine that the object update 408 is not novel and the object synchronization system 100 can reject the object update 408.

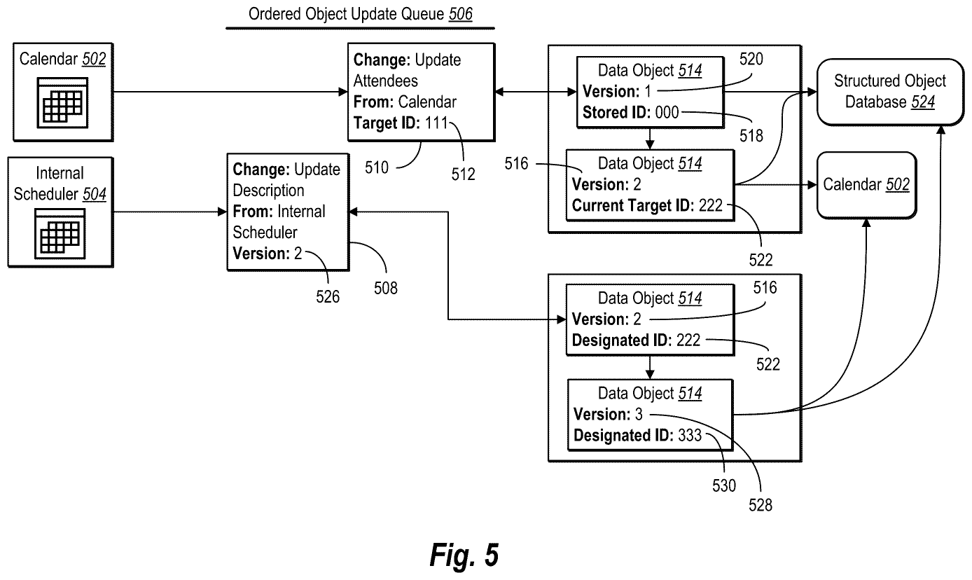

As discussed above, the object synchronization system 100 can reject stale object updates. In one or more cases, based on the type of modification (e.g., object update or target object update), the object synchronization system 100 can combine and/or merge an object update and target object update. FIG. 5 illustrates an object synchronization system 100 merging an object update and target object update in accordance with one or more embodiments. As described above, in FIG. 5, the object synchronization system 100 can receive a target object update 510 from a calendar application 502 that modifies the attendees to a scheduled event on a calendar associated with the calendar application 502. As discussed above, the object synchronization system 100 can determine a designated object version 516 for a data object 514 by comparing the target object version identifier 512 with the stored object version identifier 518 of the data object 514. Based on the novelty of the target object version identifier 512, the object synchronization system 100 can increment the stored object version 520 to generate the designated object version 516 and update the stored object version identifier 518 to a designated object version identifier 522 that reflects the most recent version of a target object and/or calendar stored on the calendar application 502.

As mentioned above, the object synchronization system 100 can store the designated object version 516 and the designated object version identifier 522 in a structured object database 524 and compare subsequent modifications (e.g., the object update 508, additional target object updates, additional object updates) with the designated object version 516 and/or the designated object version identifier 522 to determine a version of the data object 514 that reflects the most recent changes, state, and/or instance of the data object 514. For example, the designated object version 516 and/or the designated object version identifier 522 can become an additional stored object version and additional stored object version identifier for a subsequent object update and/or subsequent target object update.

As shown in FIG. 5, in some cases, the object synchronization system 100 can receive an additional modification to the data object 514 via an object update 508 from the internal scheduler 504. As shown in FIG. 5, the modification represented by the object update 508 updates a description associated with the scheduled event represented by the data object 514 and differs from the target object update 510 that modifies the attendees for the scheduled event. In one or more embodiments, the object synchronization system 100 processes the object update 508 by running a series of rules on the object update 508 and comparing an object update version 526 of the object update 508 with the designated object version 516 of the data object 514. As shown in FIG. 5, the object update version 526 matches the designated object version 516 of the data object 514. In some cases, the series of rules can allow the object synchronization system 100 to merge modifications instead of reprocessing the object update 508 in an ordered object update queue 506. For example, based on the target object update 510 and the object update 508 modifying different aspects of the data object 514, the object synchronization system 100 can merge the object update 508 and the target object update 510.

As shown in FIG. 5, the object synchronization system 100 can merge the modifications by generating a merged object version 528 and a merged object version identifier 530 that represents the most known recent and/or current state, version, and/or instance of the data object 514. As shown in FIG. 5, the object synchronization system 100 can apply or push the object update 508 to the calendar associated with the calendar application 502. In some cases, the object synchronization system 100 can push the object update 508 to one or more additional third-party applications (e.g., additional calendar applications) linked to the centralized object synchronization platform 200 for a user account. In some cases, the object synchronization system 100 can apply the object update 508 to the target application and/or one or more additional third-party applications by translating the structured computer code of the modified data object to a structure and/or format that corresponds to the target third-party application and/or the one or more additional third-party applications by utilizing the integration layer described above in FIG. 2.

Additionally, the object synchronization system 100 can store the merged object version 528 and/or the merged object version identifier 530 and utilize the stored merged object version 528 and/or merged object version identifier 530 to determine the novelty, currentness, and/or recency of subsequent modifications (e.g., object updates and/or target object updates) to the data object 514.

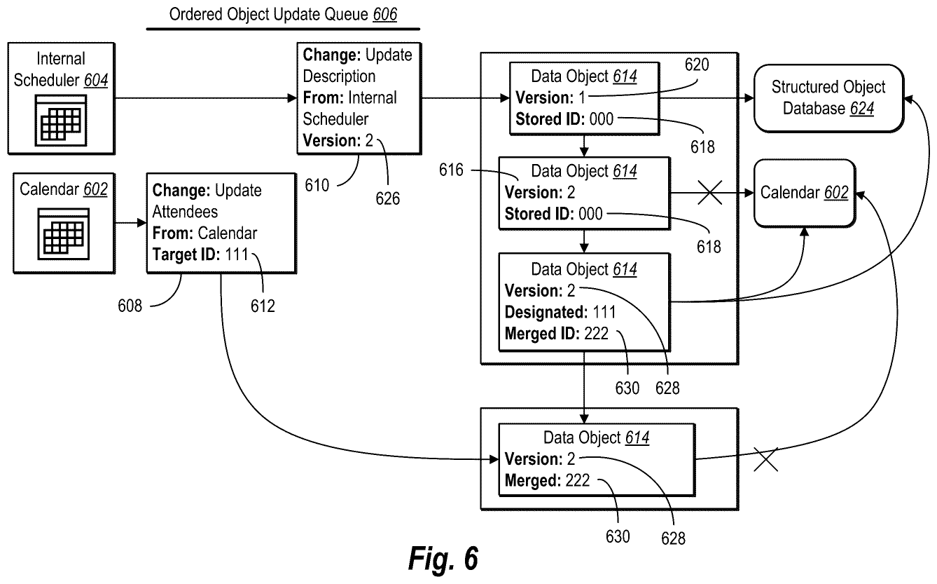

As indicated in FIGS. 3 and 4, the order of processing object updates and/or target object updates, can affect the manner of applying the object updates and/or target object updates to third-party applications linked to the centralized object synchronization platform 200 and associated with a user account. FIG. 6 illustrates another embodiment of an object synchronization system merging an object update and target object update in accordance with one or more embodiments.

As shown in FIG. 6, the object synchronization system 100 can receive an object update 610 for a data object 614 representing an object (or target object) such as a scheduled event associated with a calendar application 602 corresponding to a user account. As shown in FIG. 6, the object synchronization system 100 can receive and process an object update 610 from an internal scheduler 604 before a target object update 608 from the calendar application 602. As shown in FIG. 6, the object update 610 precedes the target object update 608 in an ordered object update queue 606. As shown in FIG. 6, the target object update 608 can include a target object version identifier 612 indicating the version of the target object on the calendar application 602.

As described above in FIG. 3, the object synchronization system 100 can process the 508 by running the 610 through a series of rules and comparing an object update version 626 of the object update 610 with a stored object version 620 of the data object 614. As described above and shown in FIG. 6, the object synchronization system 100 can determine that the object update 610 is novel based on the object update version 626 exceeding the stored object version 620 of the data object 614. Based on the novelty of the object update 610, the object synchronization system 100 can determine a designated object version 616 for the data object 614 by incrementing the stored object version 620. For example, the designated object version 616 of the data object 614 after the object update is two.

Moreover, as described above, in one or more embodiments, the object synchronization system 100 can attempt to apply the object update 610 to the calendar application 602 by comparing a stored object version identifier 618 with the most recent target object version identifier of the scheduled event and/or the calendar on the calendar application 602. As described above, since the calendar application 602 received the target object update 608 to the scheduled event on the calendar within the calendar application 602, the object synchronization system 100 is not aware of the most recent version of the scheduled event or the calendar within the calendar application 602. Accordingly, the object synchronization system 100 pulls the latest target object version identifier from the target object (e.g., scheduled event) on the calendar application 602. In one or more embodiments, while pulling the latest target object version identifier from the calendar application 602, the object synchronization system 100 recognizes the modification to the scheduled event and/or calendar associated with the target object update 608. Moreover, the object synchronization system 100 determines that the modification associated with the target object update 608 relates to a different parameter of the scheduled event within the calendar on the calendar application 602. For example, the target object update 608 relates to modifying the attendees of the scheduled event and the object update 610 relates to modifying the description of the scheduled event. Based on the target object update 608 and the object update 610 modifying different aspects of the data object 614, the object synchronization system 100 can merge the modification pulled from the calendar application 602 with the object update 610 to generate a merged object version 628 of the data object 614. In some cases, the object synchronization system 100 can generate a merged object version identifier 630 that reflects the most recent version of the scheduled event and/or the calendar on the calendar application 602.

As shown in FIG. 6, the object synchronization system 100 can apply the object update 610 and store the merged object version 628 and/or merged object version identifier 630 in a structured object database 624 to use for processing subsequent object updates and/or target object updates. For example, while the object synchronization system 100 merged the modification associated with the object update 610 and the target object update 608 by pulling the latest version of the calendar (or calendar event) from the calendar application 602, the object synchronization system 100 has not processed the target object update 608 via the ordered object update queue 606. In one or more embodiments, the object synchronization system 100 can process the target object update 608 by comparing a target object version identifier of the target object update 608 with the merged object version identifier 630 of the data object 614 stored in the structured object database 624. In one or more embodiments, the object synchronization system 100 recognized the target object update 608 as a stale update because the object synchronization system 100 applied the modification corresponding to the target object update 608 while applying the merged modifications to the scheduled event within the calendar application 602. Accordingly, in one or more embodiments, the object synchronization system 100 can reject the target object update 608.

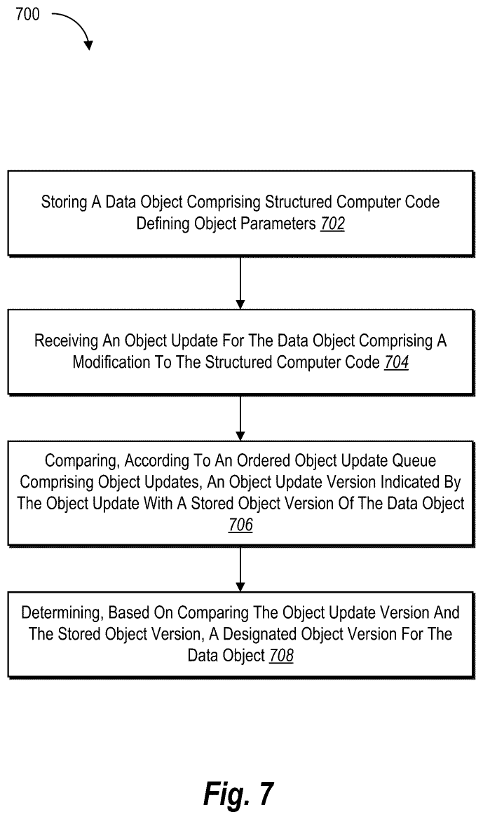

FIGS. 1-6, the corresponding text and the examples provide a number of different systems and methods for generating a response to a prompt by utilizing a context engine and a logic engine. In addition to the foregoing, implementations can also be described in terms of flowcharts comprising acts/steps in a method for accomplishing a particular result. For example, FIG. 7 illustrates an example flowchart of a series of acts for determining a designated object version of a data object in accordance with one or more embodiments.

As illustrated in FIG. 7, the series of acts 700 may include an act 702 of storing a data object comprising structured computer code defining object parameters. For example, in one or more embodiments, the act 702 can include storing, at a centralized object synchronization platform, a data object comprising structured computer code defining object parameters. In addition, the series of acts 700 includes an act 704 of receiving an object update for the data object, the object update comprising a modification to the structured computer code. For example, in one or more embodiments, the act 704 can include receiving, from a structured object database, an object update for the data object comprising a modification to the structured computer code. In addition, the series of acts 700 includes an act 706 of comparing, according to an ordered object update queue comprising object updates, an object update version indicated by the object update with a stored object version of the data object. For instance, in some implementations, the act 706 can include comparing, according to an ordered object update queue comprising object updates added in chronological order, an object update version indicated by the object update with a stored object version of the data object stored at the centralized object synchronization platform. As further illustrated in FIG. 7, the series of acts 700 includes an act 708 of determining based on comparing the object update version and the stored object version, a designated object version for the data object. For example, act 708 can include determining, based on comparing the object update version and the stored object version, a designated object version for the data object at the centralized object synchronization platform.

Further, in one or more embodiments, the series of acts 700 includes an act of receiving, from the logic engine, an error result for the prompt. Additionally, the series of acts 700 includes an act of determining that the object update version exceeds the stored object version. In one or more implementations, the series of acts 700 can include an act of based on the object update version exceeding the stored object version, generating the designated object version.

Additionally, the series of acts 700 can include receiving, from a target third-party application, a target object update for the data object comprising an additional modification to the structured computer code. In some cases, the series of acts 700 can include comparing a stored object version identifier of the stored object version with a target object version identifier of the target object update. Moreover, in one or more embodiments, the series of acts 700 can include an act of determining, based on comparing the stored object version identifier with the target object version identifier, a designated object version identifier.

Further, in one or more embodiments, the series of acts 700 includes determining that the object update version matches the stored object version. Moreover, the series of acts 700 includes based on the object update version matching the stored object version, updating the object update version of the object update and placing the object update back in the ordered object update queue.

In addition, the series of acts 700 can include receiving, in the ordered object update queue a target object update for the data object comprising an additional modification to structured computer code of the data object that differs from the modification to the structured computer code of the data object. In addition, the series of acts 700 can include generating the designated object version that merges the modification of the object update and the additional modification of the target object update.

In one or more cases, the series of acts 700 includes receiving a target object from a target third-party application linked to the centralized object synchronization platform. Moreover, in one or more embodiments, the series of acts 700 includes generating, via an integration layer, the data object by translating a structure of the target object associated with the target third-party application to the structured computer code defining the object parameters according to a standardized structure associated with the centralized object synchronization platform.

In some cases, the series of acts 700 includes applying the object update of the data object to a target third-party application linked to the centralized object synchronization platform according to a structure associated with the target third-party application.

Moreover, in one or more implementations, the series of acts 700 includes storing, at a centralized object synchronization platform, a data object comprising structured computer code defining object parameters. In one or more embodiments, the series of acts 700 can include receiving, from a structured object database, an object update for the data object comprising a modification to the structured computer code. In some cases, the series of acts 700 can include comparing, according to an ordered object update queue comprising object updates added in chronological order, an object update version indicated by the object update with a stored object version of the data object stored at the centralized object synchronization platform. Additionally, in one or more embodiments, the series of acts 700 includes determining, based on comparing the object update version and the stored object version, a designated object version for the data object at the centralized object synchronization platform. In some cases, the series of acts 700 includes applying the object update to a target third-party application linked to the centralized object synchronization platform.

Furthermore, in one or more embodiments, the series of acts 700 includes detecting a failed update status of a target third-party application associated with the object update. Additionally, in some cases, the series of acts 700 can include based on the failed update status of the target third-party application, placing the object update in a hold state. Moreover, in some implementations, the series of acts 700 includes based on detecting a change to the failed update status of the target third-party application, applying the object update to the target third-party application.

Furthermore, in one or more cases, the series of acts 700 includes determining that the object update version exceeds the stored object version. Moreover, in one or more embodiments, the series of acts 700 can include based on the object update version exceeding the stored object version, generating the designated object version. Additionally, in some cases the series of acts 700 can include storing the designated object version as an additional stored object version of the data object.

In some implementations, the series of acts 700 includes comparing a stored object version identifier associated with the target third-party application of the stored object version with a current target object version identifier associated with the target third-party application. In one or more cases, the series of acts 700 can include based on the current target object version identifier exceeding the stored object version identifier, updating the stored object version identifier to match the current target object version identifier.

In some embodiments, the series of acts 700 can include determining that the object update version matches the stored object version. Additionally, the series of acts 700 can further include based on the object update version matching the stored object version, updating the object update version of the object update. In some cases, the series of acts 700 can include place the object update back in the ordered object update queue.

Moreover, the series of acts 700 can include determining that the object update version matches the stored object version. Furthermore, the series of acts 700 can include based on the object update version matching the stored object version, rejecting the object update.

In some cases, the series of acts 700 includes receiving a target object comprising external object parameters from the target third-party application. Additionally, the series of acts 700 can include generating, via an integration layer, the data object by translating a structure of the external object parameters to the structured computer code defining the object parameters according to a standardized structure associated with the centralized object synchronization platform.

Moreover, the series of acts 700 can include applying the data object to one or more additional third-party applications linked to the centralized object synchronization platform according to a structure associated with the one or more additional third-party applications.

Further, the series of acts 700 can include storing, at a centralized object synchronization platform, a data object comprising structured computer code defining object parameters associated with a target third-party application. Moreover, the series of acts 700 includes receiving, from a structured object database, an object update for the data object comprising a modification to the structured computer code. Moreover, in some cases, the series of acts 700 includes comparing, according to an ordered object update queue comprising object updates added in chronological order, an object update version indicated by the object update with a stored object version of the data object stored at the centralized object synchronization platform. Additionally, the series of acts 700 includes determining, based on comparing the object update version and the stored object version, a designated object version for the data object at the centralized object synchronization platform. In one or more cases, the series of acts 700 includes storing the designated object version at the centralized object synchronization platform.

Additionally, in one or more implementations, the series of acts 700 can include detecting a failed update status of a target third-party application associated with the data object based on exceeding a rate limit associated with the target third-party application. Further, the series of acts 700 can include based on the failed update status of the target third-party application, placing the object update in a hold state. Furthermore, the series of acts 700 can include based on falling below the rate limit of the target third-party application, processing the object update.

In some embodiments, the series of acts 700 can include determining that the object update version exceeds the stored object version. Additionally, in one or more implementations, the series of acts 700 can include based on the object update version exceeding the stored object version, generating the designated object version by incrementing the stored object version.

Moreover, in some cases, the series of acts 700 can include comparing a stored object version identifier associated with the target third-party application of the stored object version with a current target object version identifier associated with the target third-party application. Additionally, in one or more embodiments, the series of acts 700 includes based on the current target object version identifier exceeding the stored object version identifier, updating the stored object version.

Further, the series of acts 700 can include applying the data object to a target third-party application and one or more additional third-party applications linked to the centralized object synchronization platform according to a structure associated with the target third-party application and the one or more additional third-party applications.

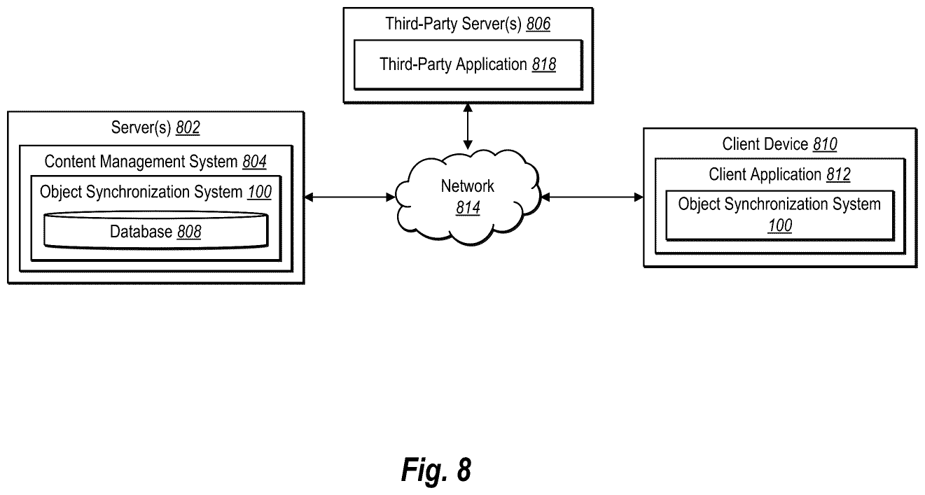

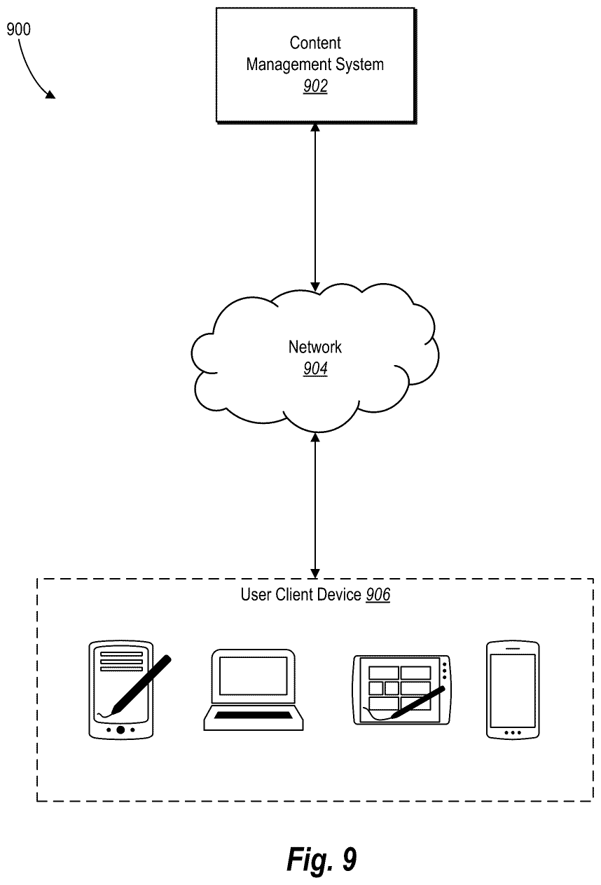

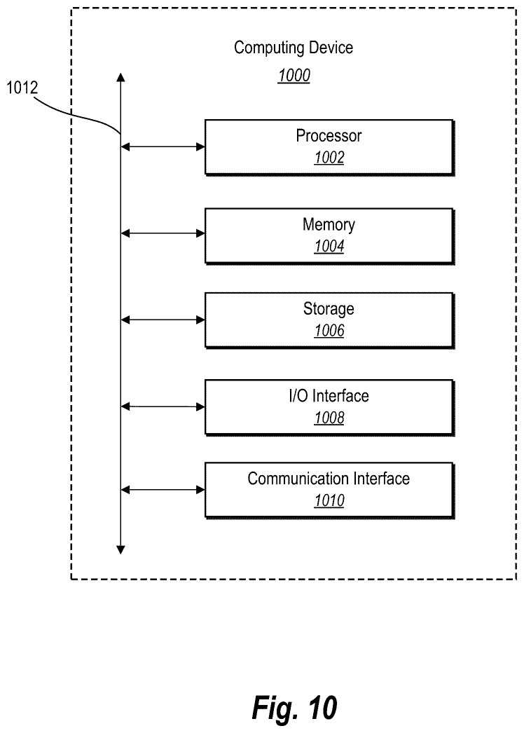

FIG. 8 illustrates a schematic diagram of an example system environment for implementing the object synchronization system 100 in accordance with one or more implementations. As shown, the environment includes server(s) 802, a client device 810, third-party server(s) 806, a database 808, and a network 814. Each of the components of the environment can communicate via the network 814, and the network 814 may be any suitable network over which computing devices can communicate. Example networks are discussed in more detail below in relation to FIGS. 9-10.

As mentioned above, the example environment includes a client device 810. The client device 810 can be one of a variety of computing devices, including a smartphone, a tablet, a smart television, a desktop computer, a laptop computer, a virtual reality device, an augmented reality device, or another computing device as described in relation to FIGS. 9-10. The client device 810 can communicate with the server(s) 802 via the network 814. For example, the client device 810 can receive user input from a user interacting with the client device 810 (e.g., via the client application 812) to, for instance, generate and/or modify an object (e.g., target object) associated with the user account and stored within the third-party server(s) 806. In addition, the object synchronization system 100 on the server(s) 802 can receive information relating to various interactions with graphical user interface elements based on the input received by the client device 810 (e.g., to change an aspect and/or parameter of an object associated with a third-party application 818).

As shown, the client device 810 can include a client application 812. In particular, the client application 812 may be a web application, a native application installed on the client device 810 (e.g., a mobile application, a desktop application, etc.), or a cloud-based application where all or part of the functionality is performed by the server(s) 802. Based on instructions from the client application 812, the client device 810 can present or display information, including a target object, corresponding to an event, item, individual, or entity.

As illustrated in FIG. 8, the example environment also includes the server(s) 802. The server(s) 802 may generate, track, store, process, receive, search, and transmit electronic data, such as digital content (e.g., content items), target objects, data objects, object updates, target object updates, additional object updates, modifications, object parameters, object update versions, stored object versions, target object version identifiers, stored object version identifiers, designated object versions, interactions with interface elements, metadata, and/or interactions between user accounts or client devices. For example, the server(s) 802 may receive data from the client device 810 in the form of modifying a scheduled event, modifying deadlines for a project, or reorganizing roles within an organization. In addition, the server(s) 802 can transmit data to the client device 810 in the form of a graphical user interface that includes a window, tab, and/or input field for receiving a modification to a target object and/or additional object. Indeed, the server(s) 802 can communicate with the client device 810 to send and/or receive data via the network 814. In some implementations, the server(s) 802 comprise(s) a distributed server where the server(s) 802 include(s) a number of server devices distributed across the network 814 and located in different physical locations. The server(s) 802 can comprise one or more content servers, application servers, communication servers, web-hosting servers, machine learning server, and other types of servers.

As shown in FIG. 8, the server(s) 802 can also include the object synchronization system 100 as part of a content management system 804. The content management system 804 can communicate with the client device 810 to perform various functions associated with generating and/or modifying a target object and/or data object. Indeed, the content management system 804 can include a network-based smart cloud storage system to manage, store, synchronize, version and maintain versions of one or more data objects, one or more target objects, and/or object updates associated with user accounts within the content management system (or centralized object synchronization platform) and link the content management system 804 to third-party applications external to the content management system 804 that are connected to the content management system via one or more software connectors. In some embodiments, object synchronization system 100 and/or the content management system 804 utilize a database 808 (e.g., structured object database) to store source content items, target objects, data objects, object updates, designated object versions, and/or designated object version identifiers.

FIG. 8 further illustrates a third-party server(s) 806. In particular, the third-party server(s) 806 can host or house a third-party application 818 that includes or that searches or generates (as part of its native application functions) one or more target objects. For example, the third-party server(s) 806 can include a server location hosting the third-party application 818 that is external to the object synchronization system 100 and the content management system 804. In some cases, the third-party server(s) 806 is external to the object synchronization system 100, but the object synchronization system 100 can nevertheless access the third-party application 818 via one or more, connectors, plugins, APIs, or other network-based access protocols.

Although FIG. 8 depicts the object synchronization system 100 located on the server(s) 802, in some implementations, the object synchronization system 100 may be implemented by (e.g., located entirely or in part on) one or more other components of the environment. For example, the object synchronization system 100 may be implemented by the client device 810 and/or a third-party device. For example, the client device 810 can download all or part of the object synchronization system 100 for implementation independent of, or together with, the server(s) 802.

In some implementations, though not illustrated in FIG. 8, the environment may have a different arrangement of components and/or may have a different number or set of components altogether. For example, the client device 810 may communicate directly with the object synchronization system 100 bypassing the network 814. As another example, the environment can include the database 808 located external to the server(s) 802 (e.g., in communication via the network 814) or located on the server(s) 802, on a third-party server(s) 806, and/or on the client device 810.

In one or more implementations, each of the components of the object synchronization system 100 are in communication with one another using any suitable communication technologies. Additionally, the components of the object synchronization system 100 can be in communication with one or more other devices including one or more client devices described above. It will be recognized that in as much the object synchronization system 100 is shown to be separate in the above description, any of the subcomponents may be combined into fewer components, such as into a single component, or divided into more components as may serve a particular implementation.

FIG. 9 is a schematic diagram illustrating environment 900 within which one or more implementations of the object synchronization system 100 can be implemented. As discussed above with respect to FIG. 8, in some embodiments, the object synchronization system 100 can be part of a content management system 902. In one or more embodiments, the content management system 902 may generate, store, manage, receive, and send digital content (such as digital videos). For example, content management system 902 may send and receive digital content to and from the user client device 906 by way of network 904. In particular, the content management system 902 can store and manage a collection of digital content. The content management system 902 can manage the sharing of digital content between computing devices associated with a plurality of users. For instance, the content management system 902 can facilitate a user sharing a digital content with another user of content management system 902.

In particular, the content management system 902 can manage synchronizing digital content across multiple of the user client device 906 associated with one or more users. For example, a user may edit digital content using user client device 906. The content management system 902 can cause user client device 906 to send the edited digital content to content management system 902. Content management system 902 then synchronizes the edited digital content on one or more additional computing devices.

In addition to synchronizing digital content across multiple devices, one or more implementations of content management system 902 can provide an efficient storage option for users that have large collections of digital content. For example, content management system 902 can store a collection of digital content on content management system 902, while the user client device 906 only stores reduced-sized versions of the digital content. A user can navigate and browse the reduced-sized versions (e.g., a thumbnail of a digital image) of the digital content on user client device 906. In particular, one way in which a user can experience digital content is to browse the reduced-sized versions of the digital content on user client device 906.

Another way in which a user can experience digital content is to select a reduced-size version of digital content to request the full-or high-resolution version of digital content from content management system 902. In particular, upon a user selecting a reduced-sized version of digital content, user client device 906 sends a request to content management system 902 requesting the digital content associated with the reduced-sized version of the digital content. Content management system 902 can respond to the request by sending the digital content to user client device 906. User client device 906, upon receiving the digital content, can then present the digital content to the user. In this way, a user can have access to large collections of digital content while minimizing the amount of resources used on user client device 906.

User client device 906 may be a desktop computer, a laptop computer, a tablet computer, a personal digital assistant (PDA), an in-or out-of-car navigation system, a handheld device, a smart phone or other cellular or mobile phone, or a mobile gaming device, other mobile device, or other suitable computing devices. User client device 906 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 904.

Network 904 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which user client devices 906 may access content management system 902.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

FIG. 10 illustrates a block diagram of exemplary computing device 1000 that may be configured to perform one or more of the processes described above. The components of the object synchronization system 100 can include software, hardware, or both. For example, the components of the object synchronization system 100 can include one or more instructions stored on a computer-readable storage medium and executable by processors of one or more computing devices (e.g., the computing device 1000). When executed by the one or more processors, the computer-executable instructions of the object synchronization system 100 can cause the computing device 1000 to perform the methods described herein. Alternatively, the components of the object synchronization system 100 can comprise hardware, such as a special purpose processing device to perform a certain function or group of functions. Additionally, or alternatively, the components of the object synchronization system 100 can include a combination of computer-executable instructions and hardware.

Furthermore, the components of the object synchronization system 100 performing the functions described herein may, for example, be implemented as part of a stand-alone application, as a module of an application, as a plug-in for applications including content management applications, as a library function or functions that may be called by other applications, and/or as a cloud-computing model. Thus, the components of the object synchronization system 100 may be implemented as part of a stand-alone application on a personal computing device or a mobile device.

Implementations of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

As mentioned, FIG. 10 illustrates a block diagram of exemplary computing device 1000 that may be configured to perform one or more of the processes described above. One will appreciate that third-party server(s) 806, the client device 810, and/or the computing device 1000 may comprise one or more computing devices such as computing device 1000. As shown by FIG. 10, computing device 1000 can comprise processor 1002, memory 1004, a storage device, a I/O interface, and communication interface 1010, which may be communicatively coupled by way of communication infrastructure 1012. While an exemplary computing device 1000 is shown in FIG. 10, the components illustrated in FIG. 10 are not intended to be limiting. Additional or alternative components may be used in other implementations. Furthermore, in certain implementations, computing device 1000 can include fewer components than those shown in FIG. 10. Components of computing device 1000 shown in FIG. 10 will now be described in additional detail.

In particular implementations, processor 1002 includes hardware for executing instructions, such as those making up a computer program. As an example, and not by way of limitation, to execute instructions, processor 1002 may retrieve (or fetch) the instructions from an internal register, an internal cache, memory 1004, or storage device 1006 and decode and execute them. In particular implementations, processor 1002 may include one or more internal caches for data, instructions, or addresses. As an example, and not by way of limitation, processor 1002 may include one or more instruction caches, one or more data caches, and one or more translation lookaside buffers (TLBs). Instructions in the instruction caches may be copies of instructions in memory 1004 or storage device 1006.

Memory 1004 may be used for storing data, metadata, and programs for execution by the processor(s). Memory 1004 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. Memory 1004 may be internal or distributed memory.

Storage device 1006 includes storage for storing data or instructions. As an example, and not by way of limitation, storage device 1006 can comprise a non-transitory storage medium described above. Storage device 1006 may include a hard disk drive (HDD), a floppy disk drive, flash memory, an optical disc, a magneto-optical disc, magnetic tape, or a Universal Serial Bus (USB) drive or a combination of two or more of these. Storage device 1006 may include removable or non-removable (or fixed) media, where appropriate. Storage device 1006 may be internal or external to computing device 1000. In particular implementations, storage device 1006 is non-volatile, solid-state memory. In other implementations, Storage device 1006 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1008 allows a user to provide input to, receive output from, and otherwise transfer data to and receive data from computing device 1000. I/O interface 1008 may include a mouse, a keypad or a keyboard, a touch screen, a camera, an optical scanner, network interface, modem, other known I/O devices or a combination of such I/O interfaces. I/O interface 1008 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1008 is configured to provide graphical data to a display for presentation to a user. The graphical data may be representative of one or more graphical interfaces and/or any other graphical content as may serve a particular implementation.

Communication interface 1010 can include hardware, software, or both. In any event, communication interface 1010 can provide one or more interfaces for communication (such as, for example, packet-based communication) between computing device 1000 and one or more other computing devices or networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1010 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1010 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1010 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1012 may include hardware, software, or both that couples components of computing device 1000 to each other. As an example and not by way of limitation, communication infrastructure 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
storing, at a centralized object synchronization platform, a data object comprising structured computer code defining object parameters;
receiving, from a structured object database, an object update for the data object, the object update comprising a modification to the structured computer code;
comparing, according to an ordered object update queue comprising object updates added in chronological order, an object update version indicated by the object update with a stored object version of the data object stored at the centralized object synchronization platform; and
determining, based on comparing the object update version and the stored object version, a designated object version for the data object at the centralized object synchronization platform.

2. The computer-implemented method of claim 1, further comprising:
determining that the object update version exceeds the stored object version; and
based on the object update version exceeding the stored object version, generating the designated object version.

3. The computer-implemented method of claim 1, further comprising:
receiving, from a target third-party application, a target object update for the data object comprising an additional modification to the structured computer code;
comparing a stored object version identifier of the stored object version with a target object version identifier of the target object update; and
determining, based on comparing the stored object version identifier with the target object version identifier, a designated object version identifier.

4. The computer-implemented method of claim 1, further comprising:
determining that the object update version matches the stored object version; and
based on the object update version matching the stored object version, updating the object update version of the object update and placing the object update back in the ordered object update queue.

5. The computer-implemented method of claim 1, further comprising:
receiving, in the ordered object update queue a target object update for the data object comprising an additional modification to structured computer code of the data object that differs from the modification to the structured computer code of the data object; and
generating the designated object version that merges the modification of the object update and the additional modification of the target object update.

6. The computer-implemented method of claim 1, further comprising:
receiving a target object from a target third-party application linked to the centralized object synchronization platform; and
generating, via an integration layer, the data object by translating a structure of the target object associated with the target third-party application to the structured computer code defining the object parameters according to a standardized structure associated with the centralized object synchronization platform.

7. The computer-implemented method of claim 1, further comprising:
applying the object update of the data object to a target third-party application linked to the centralized object synchronization platform according to a structure associated with the target third-party application.

8. A system comprising:
at least one processor; and
a non-transitory computer-readable medium storing instructions which, when executed by the at least one processor, cause the system to:
store, at a centralized object synchronization platform, a data object comprising structured computer code defining object parameters;
receive, from a structured object database, an object update for the data object comprising a modification to the structured computer code;
compare, according to an ordered object update queue comprising object updates added in chronological order, an object update version indicated by the object update with a stored object version of the data object stored at the centralized object synchronization platform;
determine, based on comparing the object update version and the stored object version, a designated object version for the data object at the centralized object synchronization platform; and
apply the object update to a target third-party application linked to the centralized object synchronization platform.

9. The system of claim 8 further comprising instructions, which when executed by the at least one processor cause the system to:
detect a failed update status of a target third-party application associated with the object update;
based on the failed update status of the target third-party application, place the object update in a hold state; and
based on detecting a change to the failed update status of the target third-party application, apply the object update to the target third-party application.

10. The system of claim 8 further comprising instructions, which when executed by the at least one processor cause the system to:
determine that the object update version exceeds the stored object version;
based on the object update version exceeding the stored object version, generate the designated object version; and
store the designated object version as an additional stored object version of the data object.

11. The system of claim 8, further comprising instructions, which when executed by the at least one processor cause the system to:
compare a stored object version identifier associated with the target third-party application of the stored object version with a current target object version identifier associated with the target third-party application; and
based on the current target object version identifier exceeding the stored object version identifier, update the stored object version identifier to match the current target object version identifier.

12. The system of claim 8 further comprising instructions, which when executed by the at least one processor cause the system to:
determine that the object update version matches the stored object version;
based on the object update version matching the stored object version, update the object update version of the object update; and
place the object update back in the ordered object update queue.

13. The system of claim 8 further comprising instructions, which when executed by the at least one processor cause the system to:
determine that the object update version matches the stored object version; and
based on the object update version matching the stored object version, reject the object update.

14. The system of claim 8 further comprising instructions, which when executed by the at least one processor cause the system to:
receive a target object comprising external object parameters from the target third-party application; and
generate, via an integration layer, the data object by translating a structure of the external object parameters to the structured computer code defining the object parameters according to a standardized structure associated with the centralized object synchronization platform.

15. The system of claim 8 further comprising instructions, which when executed by the at least one processor cause the system to:
apply the data object to one or more additional third-party applications linked to the centralized object synchronization platform according to a structure associated with the one or more additional third-party applications.

16. A non-transitory computer-readable medium storing executable instructions which, when executed by at least one processor, cause the at least one processor to:
store, at a centralized object synchronization platform, a data object comprising structured computer code defining object parameters associated with a target third-party application;
receive, from a structured object database, an object update for the data object comprising a modification to the structured computer code;
compare, according to an ordered object update queue comprising object updates added in chronological order, an object update version indicated by the object update with a stored object version of the data object stored at the centralized object synchronization platform;
determine, based on comparing the object update version and the stored object version, a designated object version for the data object at the centralized object synchronization platform; and
store the designated object version at the centralized object synchronization platform.

17. The non-transitory computer-readable medium of claim 16, further storing instructions which, when executed by the at least one processor, cause the at least one processor to:
detect a failed update status of a target third-party application associated with the data object based on exceeding a rate limit associated with the target third-party application;
based on the failed update status of the target third-party application, place the object update in a hold state; and
based on falling below the rate limit of the target third-party application, process the object update.

18. The non-transitory computer-readable medium of claim 16, further storing instructions which, when executed by the at least one processor, cause the at least one processor to:
determine that the object update version exceeds the stored object version; and
based on the object update version exceeding the stored object version, generate the designated object version by incrementing the stored object version.

19. The non-transitory computer-readable medium of claim 16, further storing instructions which, when executed by the at least one processor, cause the at least one processor to:
compare a stored object version identifier associated with the target third-party application of the stored object version with a current target object version identifier associated with the target third-party application; and
based on the current target object version identifier exceeding the stored object version identifier, update the stored object version.

20. The non-transitory computer-readable medium of claim 16, further storing instructions which, when executed by the at least one processor, cause the at least one processor to:
apply the data object to a target third-party application and one or more additional third-party applications linked to the centralized object synchronization platform according to a structure associated with the target third-party application and the one or more additional third-party applications.
